(19) United States
(12) Patent Application Publication
(10) Pub. No.: US 2025/0037414 A1
(43) Pub. Date: Jan. 30, 2025

(54) OPTIMALLY DIVIDING DATASET DISTRIBUTIONS

(71) Applicant: INTERNATIONAL BUSINESS MACHINES CORPORATION, Armonk, NY (US)

(72) Inventors: Irene Lizeth MANOTAS GUTIÉRREZ, White Plains, NY (US); Jonathan D. DUNNE, Dungarvan (IE); Mary Diane SWIFT, Rochester, NY (US); Sonya LEECH, Trim (IE)

(21) Appl. No.: 18/358,504

(22) Filed: Jul. 25, 2023

(51) Int. Cl. G06V 10/50; G06V 10/48; G06V 10/74; G06V 40/10

(52) U.S. Cl. CPC G06V 10/50; G06V 10/48; G06V 10/761; G06V 40/10

(57) ABSTRACT

A computer-implemented method includes receiving a dataset. The method further includes generating a histogram distribution of the dataset. The method further includes identifying an elbow/knee point by iteratively analyzing the histogram distribution based on y-axis values. The method further includes determining histogram bin significance of the histogram distribution using a central tendency value. The method further includes determining a most extreme difference histogram bin of the histogram distribution based on the histogram distribution, the elbow/knee point, and the histogram bin significance. The method further includes mapping the most extreme difference histogram bin to the dataset. The method further includes splitting the dataset into a head dataset and a tail dataset at the most extreme difference histogram bin. The method further includes outputting an indication of the head dataset and the tail dataset.

### BACKGROUND

Aspects of the present invention relate generally to statistical analysis, and more specifically, to dividing empirical distributions.

### SUMMARY

In a first aspect of the invention, there is a computer-implemented method including receiving a dataset. The computer-implemented method further includes generating a histogram distribution of the dataset. The computer-implemented method further includes identifying an elbow/knee point by iteratively analyzing the histogram distribution based on y-axis values. The computer-implemented method further includes determining histogram bin significance of the histogram distribution using a central tendency value. The computer-implemented method further includes determining a most extreme difference histogram bin of the histogram distribution based on the histogram distribution, the elbow/knee point, and the histogram bin significance. The computer-implemented method further includes mapping the most extreme difference histogram bin to the dataset. The computer-implemented method further includes splitting the dataset into a head dataset and a tail dataset at the most extreme difference histogram bin. The computer-implemented method further includes outputting an indication of the head dataset and the tail dataset.

In another aspect of the invention, there is a computer program product including one or more computer readable storage media having program instructions collectively stored on the one or more computer readable storage media. The program instructions are executable to receive a dataset. The program instructions are further executable to generate a histogram distribution of the dataset. The program instructions are further executable to identify an elbow/knee point by iteratively analyzing the histogram distribution based on y-axis values. The program instructions are further executable to determine histogram bin significance of the histogram distribution using a central tendency value. The program instructions are further executable to determine a most extreme difference histogram bin of the histogram distribution based on the histogram distribution, the elbow/knee point, and the histogram bin significance. The program instructions are further executable to map the most extreme difference histogram bin to the dataset. The program instructions are further executable to split the dataset into a head dataset and a tail dataset at the most extreme difference histogram bin. The program instructions are further executable to output an indication of the head dataset and the tail dataset.

In another aspect of the invention, there is a system including a processor set, one or more computer readable storage media, and program instructions collectively stored on the one or more computer readable storage media. The program instructions are executable to receive a dataset. The program instructions are further executable to generate a histogram distribution of the dataset. The program instructions are further executable to identify an elbow/knee point by iteratively analyzing the histogram distribution based on y-axis values. The program instructions are further executable to determine histogram bin significance of the histogram distribution using a central tendency value. The program instructions are further executable to determine a most extreme difference histogram bin of the histogram distribution based on the histogram distribution, the elbow/knee point, and the histogram bin significance. The program instructions are further executable to map the most extreme difference histogram bin to the dataset. The program instructions are further executable to split the dataset into a head dataset and a tail dataset at the most extreme difference histogram bin. The program instructions are further executable to output an indication of the head dataset and the tail dataset.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a flowchart of an exemplary method in accordance with aspects of the present invention.

FIG. 4A depicts a method portion that dataset distribution division code may perform, in accordance with aspects of the present invention.

FIG. 4B depicts a method portion that dataset distribution division code may perform, continuing on the method portion depicted in FIG. 4A, in accordance with aspects of the present invention.

FIG. 4C depicts a method portion that dataset distribution division code may perform. continuing on method portions depicted in FIGS. 4A, 4B, in accordance with aspects of the present invention.

FIG. 4D depicts a method portion that dataset distribution division code may perform, continuing on method portions depicted in FIGS. 4A, 4B, 4C in accordance with aspects of the present invention.

### DETAILED DESCRIPTION

Aspects of the present invention relate generally to statistical analysis, and more specifically, to dividing empirical distributions. Distribution fitting is valuable because the process enables modeling of univariate data. If the probability density distribution of an underlying dataset is determined, the parameters of the probability density distribution can be used for a variety of useful downstream purposes. If a distribution cannot be fitted, alternatives can derive a curve function for each empirical dataset using integral calculus techniques, attempt a non-parametric approach such as Kernel Density Estimation (KDE), or use a “distribution free” technique that enables “wrapping a curve function” around a dataset. Another alternative approach is to use Maximum Likelihood Estimation (MLE) to detect change points in datasets. However, this approach may not obtain an optimal split point due to the random nature or convergence of the process. While the above techniques are computationally expensive or stochastic in nature, aspects of the present disclosure may instead advantageously provide an inexpensive approach using linear algebra.

Various examples of this disclosure pertain to a method and system for dividing a dataset distribution. The method and system may further include generating a histogram distribution of the dataset. The method and system may further include identifying an elbow/knee point by iteratively analyzing the histogram according to y-axis values. The method and system may further include determining histogram bin significance using a central tendency value. The method and system may further include determining a most extreme difference histogram bin according to the histogram distribution, the elbow/knee point, and the histogram bin significance. The method and system may further include mapping the most extreme histogram bin to the dataset. The method and system may further include splitting the dataset into a head and a tail according to the most extreme histogram bin. The method and system may further include determining fit parameters for the head and the tail. The method and system may further include providing the fit parameters for the head and the tail.

Implementations of the invention are necessarily rooted in computer technology. Various implementations of this disclosure may collect any arbitrary number of datasets of any arbitrary size from anywhere in the world via cloud systems and perform complex statistical analysis on them to generate useful and inventive outputs in a fraction of a second. Analogous to machine learning and artificial intelligence applications, aspects of the present invention include highly advanced and cloud based machines for outputting products of statistical analysis in real-time or near real-time. These aspects of the present invention are a highly advanced and cloud based statistical analysis system that cannot be replicated by human beings working alone using the human mind or with pen and paper. In other words, aspects of the present invention go beyond what anyone could have imagined or thought possible before their introduction.

It should be understood that, to the extent implementations of the invention collect, store, or employ personal information provided by, or obtained from, individuals (for example, any kinds of sets of data potentially including any personal, protected, or potentially sensitive data), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as dataset distribution division code 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

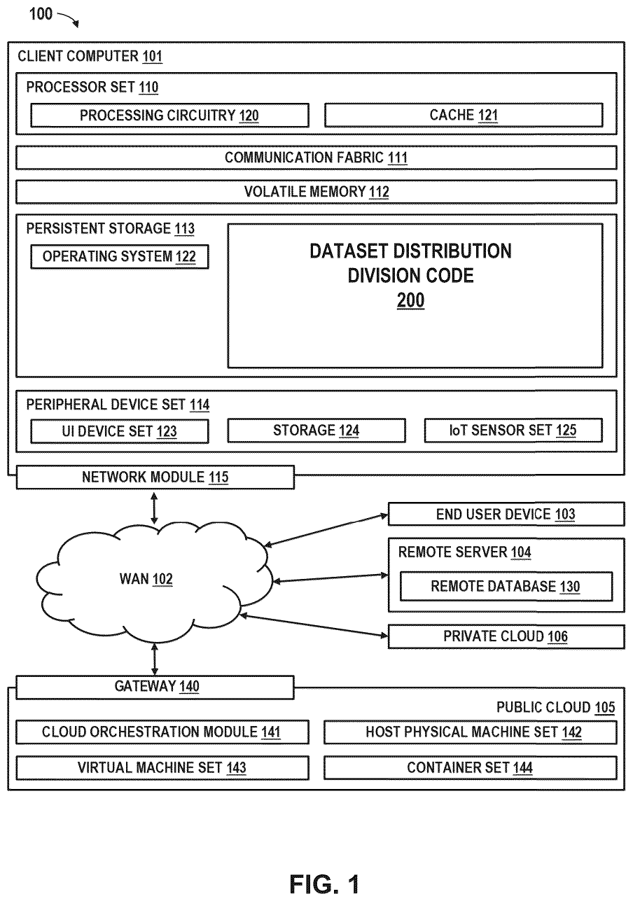

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

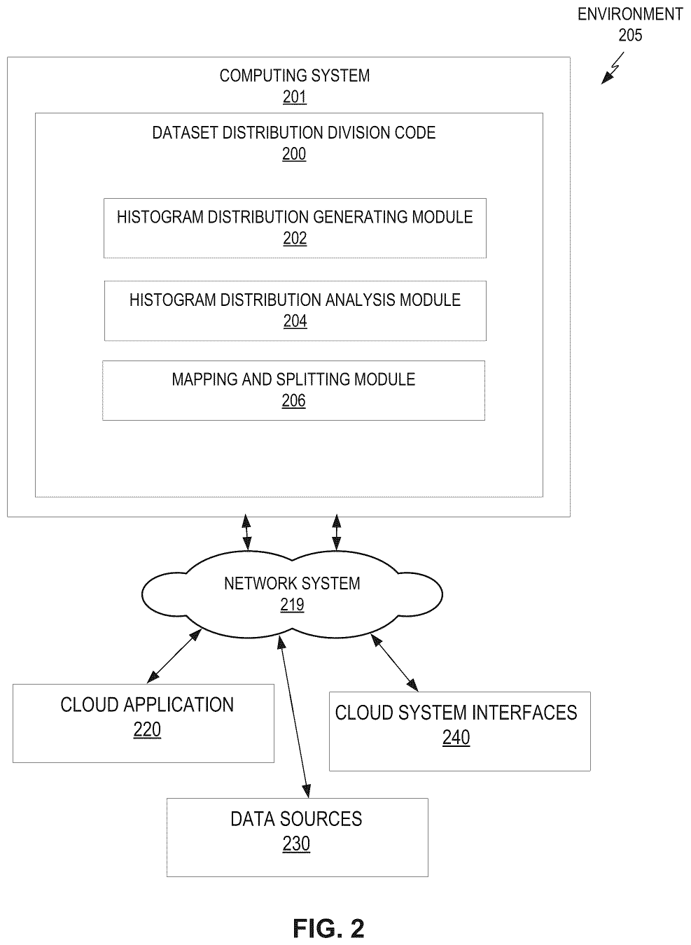

FIG. 2 shows a block diagram of an exemplary environment 205 in accordance with aspects of the invention. In embodiments, the environment includes computing system 201. which implements example dataset distribution division code 200, as introduced above with reference to FIG. 1. In various embodiments, dataset distribution division code 200 of FIG. 2 comprises histogram distribution generating module 202, histogram distribution analysis module 204, and mapping and splitting module 206. Histogram distribution analysis module 204 may identify an elbow/knee point (i.e., vertex or inflection point of the function graph) by iteratively analyzing the histogram distribution based on y-axis values. Histogram distribution analysis module 204 may also determine histogram bin significance, or relative significance of the histogram bins, of the histogram distribution using a central tendency value. Histogram distribution analysis module 204 may also split the dataset into a head dataset and a tail dataset at the most extreme difference histogram bin. Each of modules 202, 204, and 206 may comprise modules of the code of block 200 of FIG. 1.

Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. Dataset distribution division code 200 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, environment 205 may include additional devices and/or networks; fewer devices and/or networks; different devices and/or networks; or differently arranged devices and/or networks than illustrated in FIG. 2.

The exemplary environment 205 also includes network system 219, cloud application 220, data sources 230, and cloud system interfaces 240. Dataset distributions division code 200 may modify and implement optimizations as a result of analysis and optimization methods described herein. In some examples, dataset distribution division code 200 may be deployed to the cloud as a cloud application, may be configured to use data sources 230 to search arbitrarily large and widespread cloud applications 220, and to interface with and perform functions described in this disclosure with an arbitrarily large and widespread number of data sources 230. Dataset distribution division code 200 may be provided and accessible to arbitrarily large numbers of users around the world as a cloud-hosted software application via cloud system interfaces 240.

Computing system 201 may be implemented in a variety of configurations for implementing, storing, running, and/or embodying dataset distribution division code 200. Computing system 201 may comprise one or more instances of computer 101 of FIG. 1, in various examples. Data sources 230 and cloud system interfaces 240 may comprise or be comprised in one or more instances of computer 101, remote server 104, private cloud 106, and public cloud 105 of FIG. 1. Dataset distribution division code 200, data sources 230, and cloud system interfaces 240 may be separate, as shown in FIG. 2. In various examples, dataset distribution division code 200 functions cooperatively with data sources 230 and cloud system interfaces 240. In various other examples, data sources 230 and cloud system interfaces 240 may be comprised as part of dataset distribution division code 200.

Network system 219 may comprise one or more instances of WAN 102, remote server 104, private cloud 106, and public cloud 105 of FIG. 1. Computing system 201 comprises a cloud-deployed computing configuration, which may comprise processing devices, memory devices, and data storage devices dispersed across data centers of a regional or global cloud computing system, with various levels of networking connections. In other words, the various levels of networking connections allow the data, code, and functions of dataset distribution division code 200 to be distributed across this cloud computing environment. Dataset distribution division code 200, computing system 201, and/or environment 205 may thus collectively constitute, comprise, and/or be considered a workflow analysis and optimizer system, and may comprise and/or be constituted of one or more software systems, a combined hardware and software system, one or more hardware systems, components, or devices, one or more methods or processes, or other embodiments.

In other examples, computing system 201 may comprise a single laptop computer, or a specialized statistical analysis workstation equipped with one or more graphics processing units (GPUs) and/or other specialized processing elements, or a collection of computers networked together in a local area network (LAN), or one or more server farms or data centers below the level of cloud deployment, or any of a wide variety of computing and processing system configurations, any of which may implement, store, run, and/or embody dataset distribution division code 200. Dataset distribution division code 200 may interact via network system 219 with any other proximate or network-connected computing systems to collect and/or process subject data from data sources 230, in various examples.

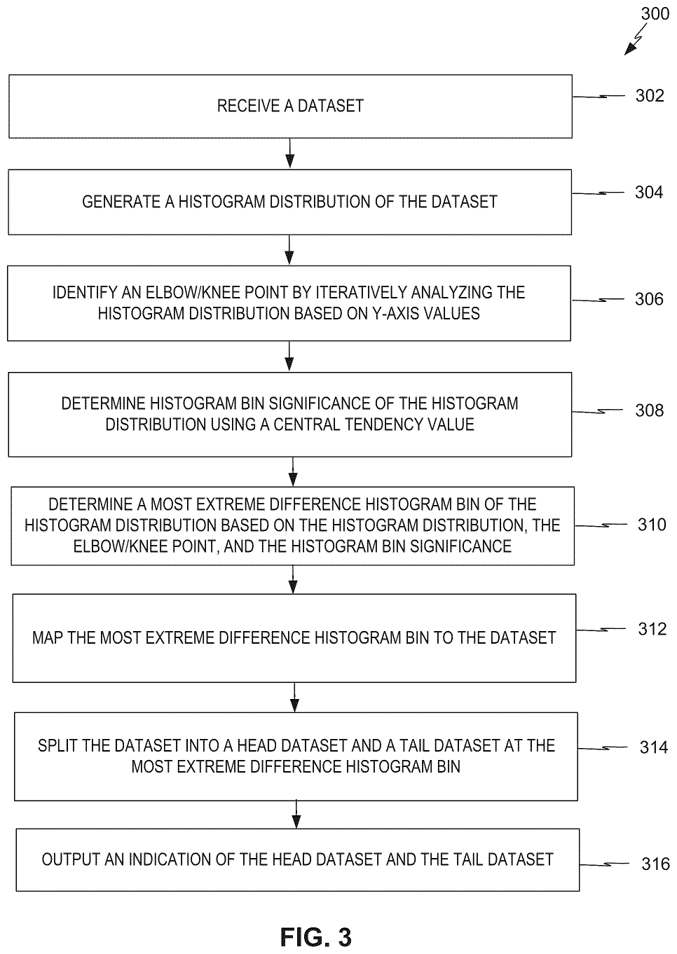

FIG. 3 shows a flowchart of an exemplary method 300 in accordance with aspects of the present invention. Steps of the method may be carried out in the environment of FIG. 2 and are described with reference to elements depicted in FIG. 2. In method 300, dataset distribution division code 200 receives a dataset (302) (e.g., via data sources 230 or cloud system interfaces 240 in response to analytical user inputs via cloud application 220 as shown in FIG. 2). In various embodiments, and as described with respect to FIG. 2, dataset distribution division code 200 (e.g., histogram distribution generating module 202 thereof) generates a histogram distribution of the dataset (304). Dataset distribution division code 200 (e.g., histogram distribution analysis module 204 thereof) identifies an elbow/knee point (i.e., vertex or inflection point of the function graph) by iteratively analyzing the histogram distribution based on y-axis values (306). Dataset distribution division code 200 (e.g., histogram distribution analysis module 204 thereof) determines histogram bin significance, or relative significance of the histogram bins, of the histogram distribution using a central tendency value (308). Dataset distribution division code 200 may use the vertical histogram column bins to construct the histogram shape and to compute the most significant inflection point. Dataset distribution division code 200 may measure the differences of y values between all bins, and based thereon, infer the relative significance by use of a central tendency such as the standard deviation. In an illustrative example, dataset distribution division code 200 may use a multiple of the standard deviation, such as three times the standard deviation, as a cutoff point to determine the extreme difference value. Dataset distribution division code 200 (e.g., histogram distribution analysis module 204 thereof) determines a most extreme difference histogram bin of the histogram distribution based on the histogram distribution, the elbow/knee point, and the histogram bin significance (310). Dataset distribution division code 200 (e.g., mapping and splitting module 206 thereof) maps the most extreme difference histogram bin to the dataset (312). Dataset distribution division code 200 (e.g., mapping and splitting module 206 thereof) splits the dataset into a head dataset and a tail dataset at the most extreme difference histogram bin (314). Dataset distribution division code 200 (e.g., mapping and splitting module 206 thereof) outputs an indication of the head dataset and the tail dataset (316). Splitting the data into such a head dataset and tail dataset may yield novel and inventive insights and fuel discovery in any realm susceptible to statistical analysis of large data sets, such as epidemiology and development of novel pharmaceutical and health treatments, financial analysis, and climate analysis.

Dataset distribution division code 200 may output the indication of the head dataset and the tail dataset in the form of outputting the head dataset and the tail dataset, or without fully outputting the head dataset and the tail dataset, such as by dividing the existing dataset as it is loaded in a memory system or a data storage system into the head dataset and the tail dataset, or by inserting an dividing indication marker in the dataset as it is loaded in a user system, or by otherwise outputting a discernible indication of the division of the dataset into the head dataset and the tail dataset, in various examples.

In an illustrative example, dataset distribution division code 200 conducts analysis of a univariate dataset. Dataset distribution division code 200 derives a distribution division model (“DVM model”) based on the analysis. Dataset distribution division code 200 uses the DVM model to divide a distribution by its “head” and “tail.” Dataset distribution division code 200 can generalize the DVM model to work across multiple heavy-tailed distribution types.

Aspects of this disclosure include the inventive combination of Freedman-Diaconis bin fitting and L-Method elbow-knee detection to determine the optimal division point of univariate data. Dataset distribution division code 200 may apply the DVM model to a multi-variate dataset to analyze sets of dependent/independent variable pairs. Dataset distribution division code 200 may apply the DVM model to perform data transformation (e.g., fit data to a Weibull distribution). Dataset distribution division code 200 may apply the DVM model to support a fully autonomous system whereby the DVM model can apply multiples of different transformations and multiples of different splits to determine the best-combined splits with the best-combined data transformations, such as by using goodness of fit scores as a reference point. As part of this, dataset distribution division code 200 may apply a transformation such as a log or square root transformation to mitigate over dispersion. Dataset distribution division code 200 may then use the DVM model to apply the split to an untransformed dataset or to a transformed data set that has been corrected for either under-dispersion or over-dispersion. Thereafter, dataset distribution division code 200 may compute the extreme difference value on the transformed dataset. For the transformed data, depending on its new shape, there could be multiple head/tail split points. In other words, performing repeated iterations of splits and data transformations may compound the value and insights gained through these methods and yield well-combined splits and data transformations.

Dataset distribution division code 200 may apply a training model that gathers descriptive statistics of the data, identifies the splits, performs data transformations, and determines and generates goodness of fit scores. Dataset distribution division code 200 may store this information in the training model. When new data is loaded for fitting, the model can use the descriptive statics to see if they have seen similar behavior and shortcut the route to the different splits and transformations applied. Dataset distribution division code 200 may store information from the splits and the data transformations in a training model. Dataset distribution division code 200 may then receive a new dataset; determine if the new dataset has similarity to the first dataset; and in response to determining that the new dataset has similarity to the first dataset, achieve a shortcut in analyzing the new dataset by applying all or some of the same splits and the same data transformations to the new dataset. Dataset distribution division code 200 may be implemented using implementations of Freedman-Diaconis and L-Method techniques, in various examples.

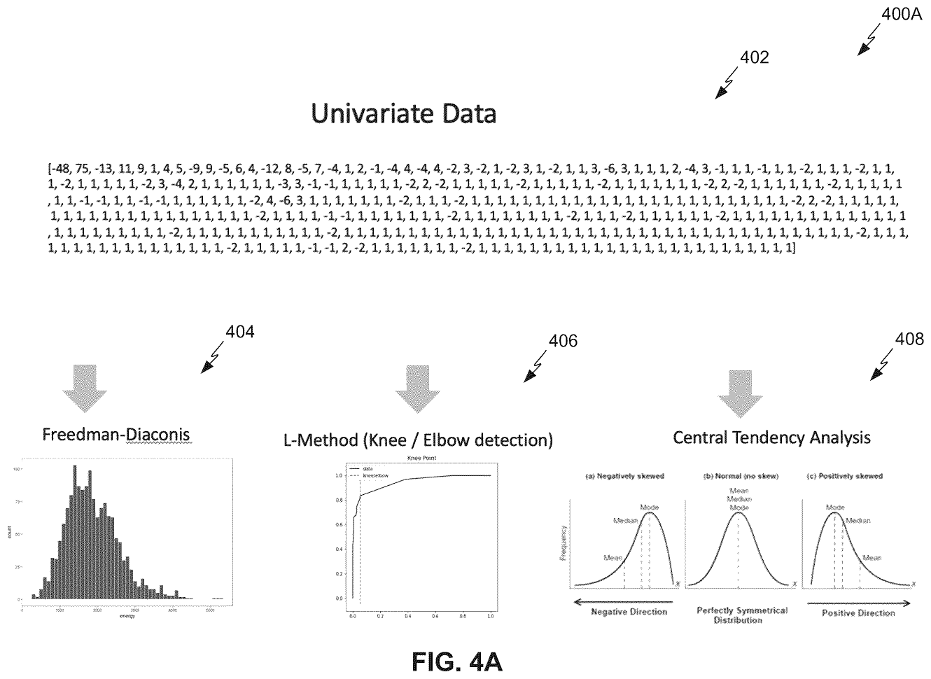

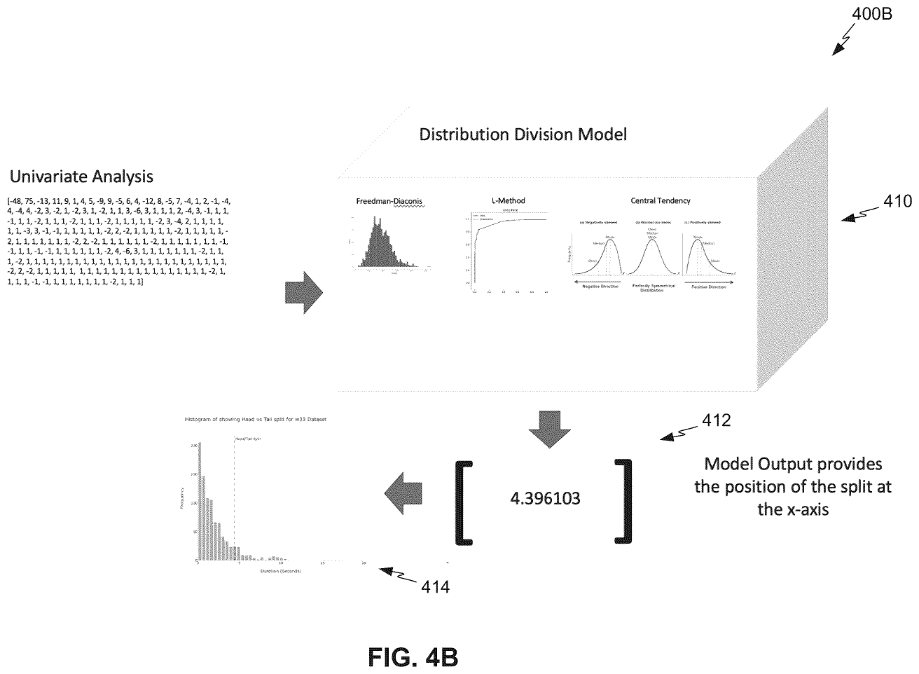

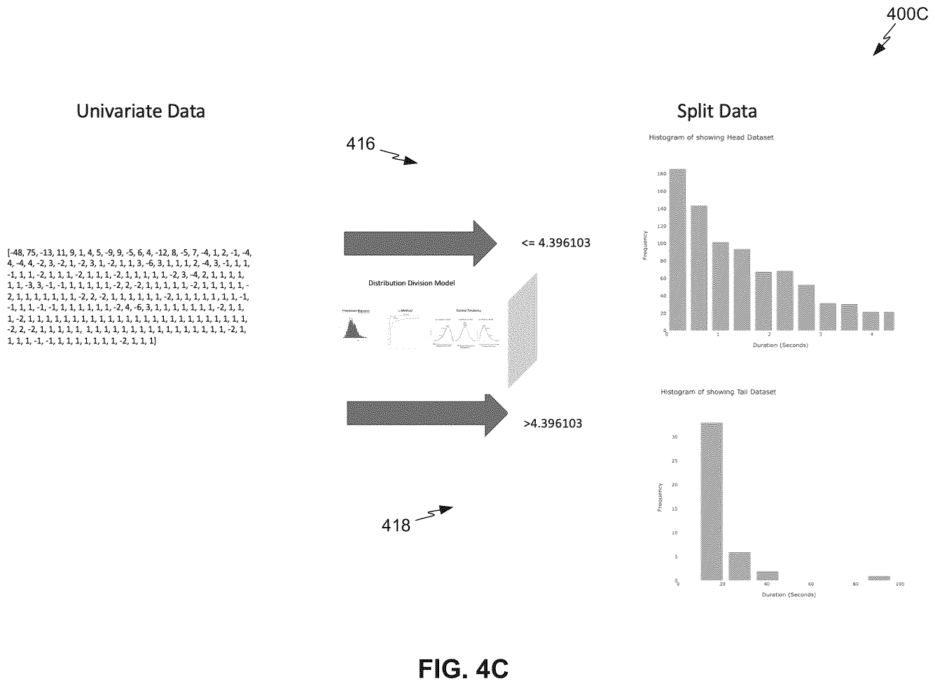

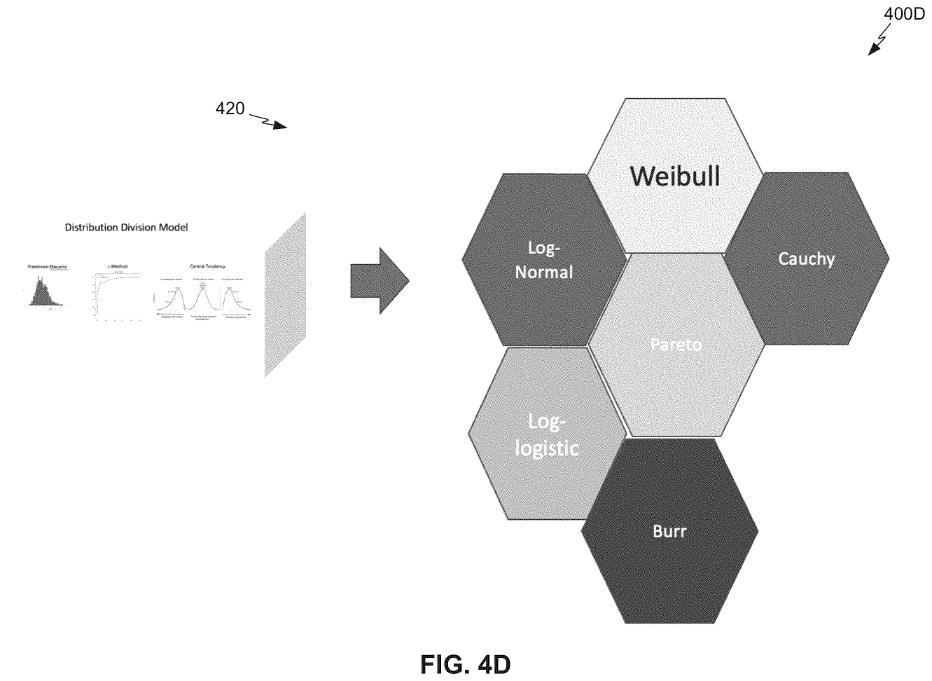

FIG. 4A depicts a method portion 400A that dataset distribution division code 200 may perform, in accordance with aspects of the present invention. Dataset distribution division code 200 may receive a univariate dataset (402, analogous to 302 in FIG. 3) and analyze the univariate data to determine the optimal number of bins using the Freedman-Diaconis method (404, as an example of 304 in FIG. 3). Dataset distribution division code 200 may iterate through the y-axis values of the histogram three positions at a time in order to calculate potential elbow or knee or vertex points (406, as an example of 306 in FIG. 3). Dataset distribution division code 200 may test the significance of the differences with each bin point using a central tendency measurement (e.g., three standard deviations) (408, as an example of 308 in FIG. 3).

FIG. 4B depicts a method portion 400B that dataset distribution division code 200 may perform, continuing on the method portion 400A depicted in FIG. 4A, in accordance with aspects of the present invention. Dataset distribution division code 200 may use the result of three pieces of analysis from method portion 400A to determine the bin location of the most extreme difference position of the slope point (410, as an example of 310 in FIG. 3). Dataset distribution division code 200 may map the most extreme difference position of the slope point back to the value of the observation from the univariate data set (412, as an example of part of 312 in FIG. 3), such as providing the position of the split on the x-axis, and overlay this position on a histogram plot (414, as an example of a further part of 312 in FIG. 3).

FIG. 4C depicts a method portion 400C that dataset distribution division code 200 may perform, continuing on method portions 400A, 400B depicted in FIGS. 4A, 4B, in accordance with aspects of the present invention. Dataset distribution division code 200 may split the data into two regions denoted as head data (416) and tail data (418), or equivalently as a head dataset and a tail dataset (as an example of 314 in FIG. 3).

FIG. 4D depicts a method portion 400D that dataset distribution division code 200 may perform, continuing on method portions 400A, 400B, 400C depicted in FIGS. 4A, 4B, 4C in accordance with aspects of the present invention. Dataset distribution division code 200 may model and analyze the datasets using goodness of fit techniques such as Anderson-Darling or Cramer-von Mises, and may further model and analyze the datasets using any of various sets of techniques such as log-normal, log-logistic, Weibull, Cauchy, Pareto, and Burr methods (420, as examples of 316 in FIG. 3). Dataset distribution division code 200 may be calibrated across a broad range of distribution types. Dataset distribution division code 200 may iteratively split a dataset at successive levels of head and tail in response to an initial fit not being found.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by one or more processing devices, a dataset;
generating, by the one or more processing devices, a histogram distribution of the dataset;
identifying, by the one or more processing devices, an elbow/knee point by iteratively analyzing the histogram distribution based on y-axis values;
determining, by the one or more processing devices, histogram bin significance of the histogram distribution using a central tendency value;
determining, by the one or more processing devices, a most extreme difference histogram bin of the histogram distribution based on the histogram distribution, the elbow/knee point, and the histogram bin significance;
mapping, by the one or more processing devices, the most extreme difference histogram bin to the dataset;
splitting, by the one or more processing devices, the dataset into a head dataset and a tail dataset at the most extreme difference histogram bin; and
outputting, by the one or more processing devices, an indication of the head dataset and the tail dataset.

2. The computer-implemented method of claim 1, further comprising:
determining fit parameters for the head dataset and the tail dataset; and
outputting the fit parameters for the head dataset and the tail dataset.

3. The computer-implemented method of claim 1, further comprising analyzing sets of dependent/independent variable pairs of a dataset, and the dataset comprising a multi-variate dataset.

4. The computer-implemented method of claim 1, further comprising performing a data transformation of the dataset.

5. The computer-implemented method of claim 1, further comprising applying multiple data transformations and multiple splits of the dataset to determine best-combined splits with best-combined data transformations.

6. The computer-implemented method of claim 5, further comprising analyzing the dataset using goodness of fit scores as a reference point.

7. The computer-implemented method of claim 6, further comprising applying a training model that gathers descriptive statistics of the data and identifies the splits, the data transformations, and the goodness of fit scores.

8. The computer-implemented method of claim 5, further comprising:
storing information from the splits and the data transformations in a training model;
receiving a new dataset;
determining if the new dataset has similarity to a first dataset; and
in response to determining that the new dataset has similarity to the first dataset, applying the splits and the data transformations to the new dataset,
wherein the dataset is the first dataset.

9. The computer-implemented method of claim 1, further comprising calibrating across a broad range of distribution types.

10. The computer-implemented method of claim 1, further comprising iteratively splitting the dataset at successive levels of the head dataset and the tail dataset.

11. A computer program product comprising one or more computer readable storage media having program instructions collectively stored on the one or more computer readable storage media, the program instructions executable to:
receive a dataset;
generate a histogram distribution of the dataset;
identify an elbow/knee point by iteratively analyzing the histogram distribution based on y-axis values;
determine histogram bin significance of the histogram distribution using a central tendency value;
determine a most extreme difference histogram bin of the histogram distribution based on the histogram distribution, the elbow/knee point, and the histogram bin significance;
map the most extreme difference histogram bin to the dataset;
split the dataset into a head dataset and a tail dataset at the most extreme difference histogram bin; and
output an indication of the head dataset and the tail dataset.

12. The computer program product of claim 11, wherein the program instructions are further executable to:
determine fit parameters for the head dataset and the tail dataset; and
output the fit parameters for the head dataset and the tail dataset.

13. The computer program product of claim 11, wherein the program instructions are further executable to analyze sets of dependent/independent variable pairs of a dataset, the dataset comprising a multi-variate dataset.

14. The computer program product of claim 11, wherein the program instructions are further executable to perform a data transformation of the dataset.

15. The computer program product of claim 11, wherein the program instructions are further executable to apply multiple data transformations and multiple splits of the dataset to determine best-combined splits with best-combined data transformations.

16. A system comprising:
a processor set, one or more computer readable storage media, and program instructions collectively stored on the one or more computer readable storage media, the program instructions executable to:
receive a dataset;
generate a histogram distribution of the dataset;
identify an elbow/knee point by iteratively analyzing the histogram distribution based on y-axis values;
determine histogram bin significance of the histogram distribution using a central tendency value;
determine a most extreme difference histogram bin of the histogram distribution based on the histogram distribution, the elbow/knee point, and the histogram bin significance;
map the most extreme difference histogram bin to the dataset;
split the dataset into a head dataset and a tail dataset at the most extreme difference histogram bin; and
output an indication of the head dataset and the tail dataset.

17. The system of claim 16, wherein the program instructions are further executable to:
determine fit parameters for the head dataset and the tail dataset; and
output the fit parameters for the head dataset and the tail dataset.

18. The system of claim 16, wherein the program instructions are further executable to analyze sets of dependent/independent variable pairs of a dataset, the dataset comprising a multi-variate dataset.

19. The system of claim 16, wherein the program instructions are further executable to perform a data transformation of the dataset.

20. The system of claim 16, wherein the program instructions are further executable to apply multiple data transformations and multiple splits of the dataset to determine best-combined splits with best-combined data transformations.
